(19) United States
(12) Patent Application Publication
(10) Pub. No.: US 2006/0282658 A1
(43) Pub. Date: Dec. 14, 2006

(54) Boot systems and methods and related devices

(75) Inventor: Ding-Chiang Tang, Changhua City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/147,709

(22) Filed: Jun. 8, 2005

(51) Int. Cl. G06F 15/177

(52) U.S. Cl. 713/2

(57) ABSTRACT

Boot systems for use in a device. The system comprises a plurality of application modules, each comprising a boot procedure for an application. If a boot signal designating at least one of the application modules is received, the device boots according to the boot procedure of the designated application module in response to the boot signal, such that the corresponding application is executed thereon.

### BACKGROUND

The present disclosure relates generally to boot systems and methods, and, more particularly to systems and methods with configurable boot procedures, and related devices.

Currently, embedded systems such as mobile phones, smart phones, and PDAs provide various functionalities comprising telecommunication, music playback, camera, game, internet services, and others, and are widely used. The services, however, are only functional after the systems are first booted. A standard boot procedure for a system is predefined, and is considered time-consuming since all software and hardware thereon must be activated. In a mobile phone, for example, the standard boot procedure comprises reading data from a SIM (Subscriber Identity Module) card, reading data from a flash RAM (Random Access Memory), and acquisition and registration of mobile networks based on specific communication protocols. The boot procedure can be inefficient and inconvenient.

In some cases, only some specific applications on a system is needed, such as making an emergency call, retrieving a contact list, or playing back music without using telecommunication services. Conventionally, it is however necessary to boot the entire system even when only one or some functions are going to be executed. Booting the entire system includes initializing all application programs. It will waste lots of time waiting for booting all applications even when none of them will be used later. Additionally, since embedded systems generally have very limited power capacity, the standard boot procedure that always boots all application programs will waste considerable power.

Conventional boot procedures of embedded systems are inefficient and inflexible even if not all services thereon are desired.

### SUMMARY

Boot systems and methods and related devices are provided.

A boot system for use in a device comprises a plurality of application modules, each comprising a boot procedure for an application. If a boot signal designating at least one of the application modules is received, the device boots according to the boot procedure of the designated application module in response to the boot signal, such that the corresponding application is executed thereby.

Another boot system for use in a device comprises a plurality of application modules and a table. Each application module comprises a sub-boot procedure for an application. The table records a plurality of boot procedures, each comprising at least one of the application modules. If a boot signal designating one of the boot procedures in the table is received, the device boots according to the designated boot procedure in response to the boot signal, such that the sub-boot procedures of the corresponding application modules are respectively executed, and applications corresponding to the respective application modules are executed thereby.

A system for use in a device comprises a plurality of application modules, a table, and an interface. Each application module comprises a sub-boot procedure for an application. The interface enables editing of at least one boot procedure comprising at least one of the application modules, and storing the boot procedure in the table. If a boot signal designating one of the boot procedures in the table is received, the device boots accordingly, such that the sub-boot procedures of the corresponding application modules are respectively executed, and applications corresponding to the respective application modules are executed thereby.

In a boot method for use in a device, a plurality of application modules is provided. Each application module comprises a boot procedure for an application. If a boot signal designating at least one of the application modules is received, the device boots accordingly, such that the corresponding application is executed thereby.

In another boot method for use in a device, a plurality of application modules and a table are provided. Each application module comprises a sub-boot procedure for an application. The table records a plurality of boot procedures, each comprising at least one of the application modules. If a boot signal designating one of the boot procedures in the table is received, the device boots accordingly, such that the sub-boot procedures of the corresponding application modules are respectively executed, and applications corresponding to the respective application modules are executed thereby.

In a method for use in a device, a plurality of application modules, and a table are provided. Each application module comprises a sub-boot procedure for an application. At least one boot procedure comprising at least one of the application modules is edited, and stored in the table. If a boot signal designating one of the boot procedures in the table is received, the device boots accordingly, such that the sub-boot procedures of the corresponding application modules are respectively executed, and applications corresponding to the respective application modules are executed thereby.

Boot systems and methods may take the form of program code embodied in tangible media. When the program code is loaded into and executed by a machine, the machine becomes an apparatus for practicing the disclosed methods.

### DESCRIPTION OF THE DRAWINGS

The invention will become more fully understood by referring to the following detailed description with reference to the accompanying drawings, wherein:

FIG. 1 is a schematic diagram illustrating an embodiment of a boot system;

FIG. 2 is a flowchart of an embodiment of a method for editing a boot procedure;

FIG. 3 is a schematic diagram illustrating an embodiment of an interface displaying application modules;

FIG. 4 is a schematic diagram illustrating an embodiment of a table of boot procedures;

FIG. 5 is a flowchart of an embodiment of a boot method;

FIG. 6 is a schematic diagram illustrating a device with full services loaded; and

FIG. 7 is a schematic diagram illustrating a device with partial services loaded.

### DESCRIPTION

Conventional mobile phones are designed to have users execute all applications. However, since some users might never use GPRS or Wi-Fi service with their mobile phone, it is advantageous for them to freely decide what they need, so that system power and memory space will be less likely to be wasted on useless booting detection process. For example, when traveling, users may choose to stop answering calls and just power on the camera function of the mobile phone. Moreover, by further removing unnecessary applications, such as video game programs, while rebooting, users can have more system memory space to store more pictures. Or, on the airplane, when communication by mobile phones is prohibited, users can choose not to boot or initiate the telecommunication applications of the mobile phone, so that they don't need to stop using other applications on the mobile phone.

Boot systems and methods and related devices are provided.

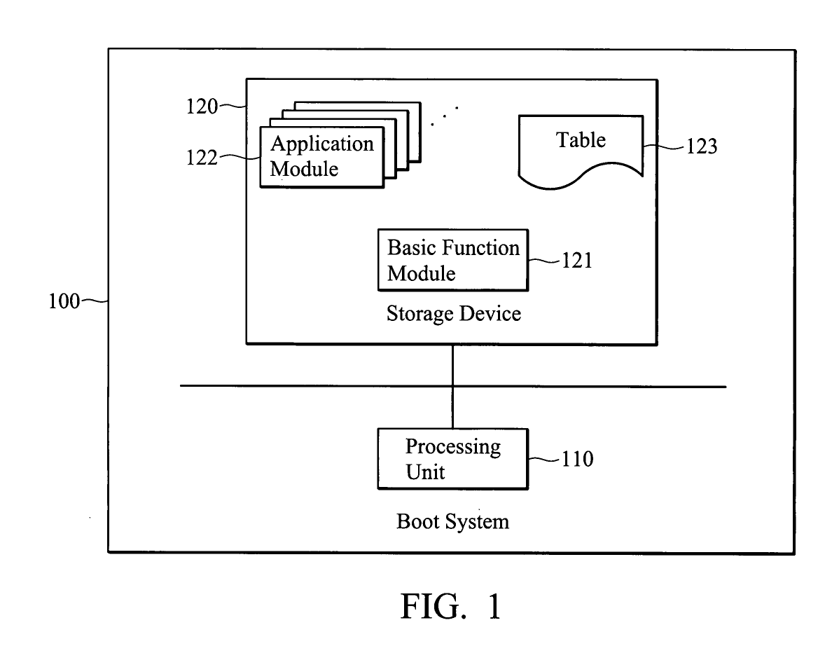

FIG. 1 is a schematic diagram illustrating an embodiment of a boot system 100.

The system 100 may be an embedded system, such as a mobile phone, a smart phone, or a PDA. The system 100 comprises a processing unit 110 and a storage device 120. The processing unit 110 may be a MCU (Micro Control Unit), such as an ARM (Advanced RISC Machines) processor, performing related calculation and control on the system 100.

The storage device 120 may be a NVRAM (Non-Volatile Random Access Memory) or a number of hardware components such as different ASIC (Application Specific Integrated Circuits) including related firmware. The storage device 120 comprises a basic function module 121, a plurality of application modules 122 and a table 123. The basic function module 121 comprises procedures necessary for system booting. For example, after power on the system 100, the basic function module 121 is operated and may trigger and supply power to hardware related to respective application module 122, to be enabled hereafter system boot. Each application module 122 corresponds to one available service on the system 100. Respective available services on the system 100 are independently designed into respective application modules 122, which may comprise any combination of software, such as a program code library, and hardware, such as a codec IC (Integrated Circuit) for a specific application (service). For example, a MP3 (MPEG audio layer-3) player module may comprise an application for music playback and a codec IC. It is understood that respective application modules 122 may utilize the same resources (software or hardware) of the system 100. In some embodiments, the application module 122 further comprises a sub-boot procedure triggering related software and hardware required for a specific application. The table 123 records a plurality of boot procedures for different situations.

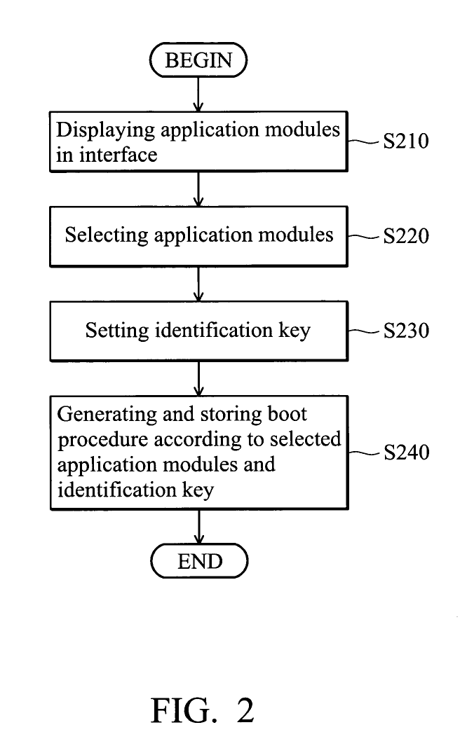

The boot procedures in the table are configurable. FIG. 2 is a flowchart of an embodiment of a method for editing a boot procedure.

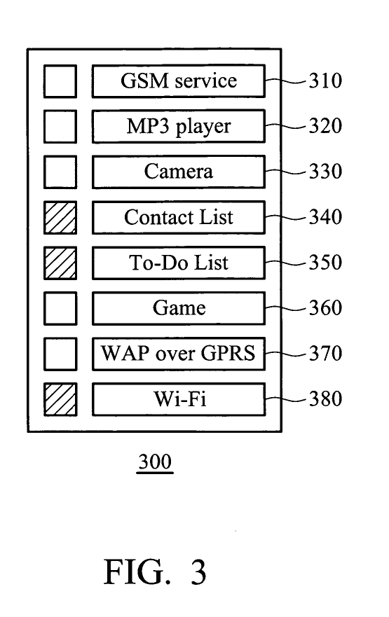

In step S210, a plurality of application modules is displayed in an interface. In some embodiments, the application modules are downloadable Java programs. Users can download the application modules from a host of a service provider. In step S220, at least one of the application modules is selected. FIG. 3 is a schematic diagram illustrating an embodiment of an interface 300 displaying application modules. In this embodiment, the available application modules comprise GSM (Global System for Mobile telecommunication) service 310, MP3 player 320, camera 330, contact list 340, to-do list 350, game 360, WAP (Wireless Application Protocol) over GPRS (General Packet Radio Service) 370, and Wi-Fi 380 modules. For example, as shown in FIG. 3, the contact list 340, to-do list 350, and Wi-Fi 380 are selected.

In step S230, an identification key for a boot procedure designating the selected application modules is set. The identification key identifies corresponding boot procedures during system boot. In some embodiments, the identification key may be long press (prolonged selection) of a power key with a specific combination of keys. It is understood that the interface 300 can comprise a field (not shown) receiving the identification key, and a field (not shown) for confirmation of changes. In step S240, a boot procedure is generated and stored according to the selected application modules and identification key.

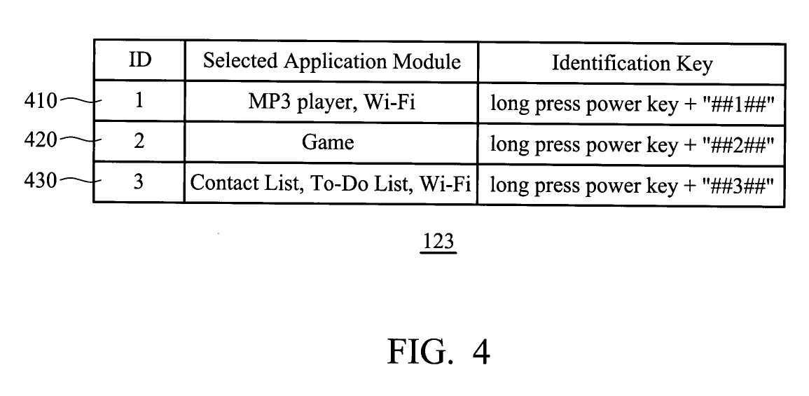

FIG. 4 is a schematic diagram illustrating an embodiment of a table 123 of boot procedures. Three boot procedures 410, 420, and 430 are in table 123. Boot procedure 410 corresponds to MP3 player 320 and Wi-Fi 380 modules, and the corresponding identification key is long press of a power key with keys “##1##”. Boot procedure 420 corresponds to game module 360, the corresponding identification key is long press of a power key with keys “##2##”. The boot procedure 430 corresponds to contact list 340, to-do list 350, and Wi-Fi 380 modules, the corresponding identification key is long press of a power key with keys “##3##”. It is understood that respective identification keys can be further modified from table 123. In some embodiment, the corresponding identification key could be a fixed bottom of a mobile phone.

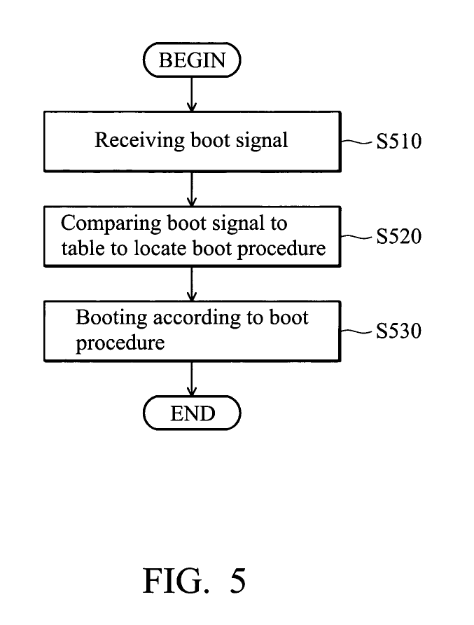

FIG. 5 is a flowchart of an embodiment of a boot method.

In step S510, a boot signal is received. The boot signal is generated based on the input identification key. In step S520, the boot signal is compared to table 123 to locate a corresponding boot procedure. In step S530, the system 100 boots according to the located boot procedure. It is understood that if the boot signal does not match any entry in table 123, the system 100 boots according to a standard boot procedure. During system boot, the basic function module 121 triggers and supplies power to hardware related to respective application module 122, to be enabled hereafter system boot, and initiates a keypad (not shown) and the storage device 120. Additionally, the boot procedure may comprise several application modules. The basic function module 121 uses function calls to start the application modules or AT commands to communicate between the application modules. If module 122 is a hardware component, a hardware IRQ signal may be used by basic function module 121 as a triggered signal. It is understood that the sub-boot procedures comprising triggering related software and hardware required for a specific application of respective application modules are respectively performed. It is also understood that application modules not designated in the boot procedure are not triggered during system boot.

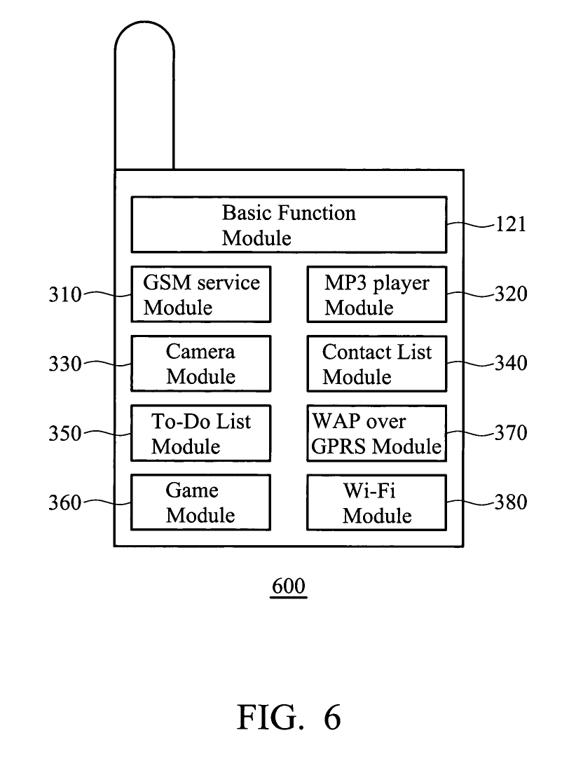

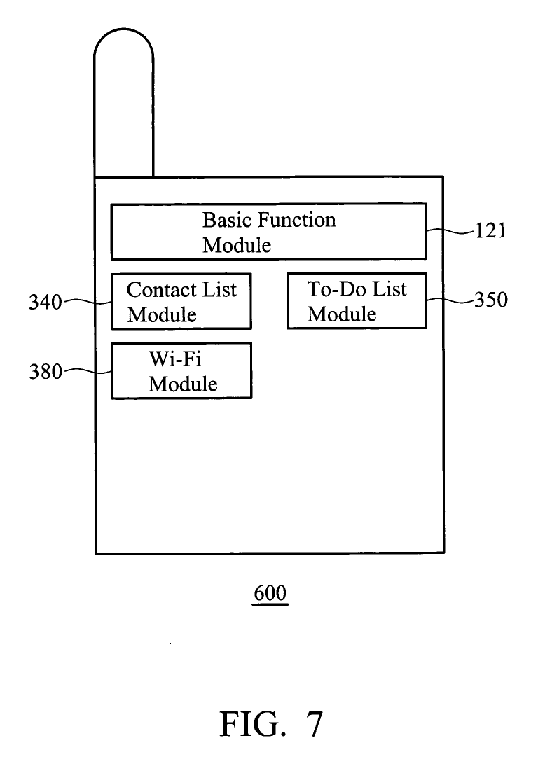

FIG. 6 is a schematic diagram illustrating a device 600 with full services loaded. After a standard boot procedure, modules comprising basic function 121, GSM service 310, MP3 player 320, camera 330, contact list 340, to-do list 350, game 360, WAP over GPRS 370, and Wi-Fi 380 modules are fully loaded on the device 600. In some embodiment, the application modules may comprise Java programs and corresponding hardware devices. If a boot signal corresponding to the boot procedure 430 in table 123 is received, the device 300 boots according to the boot procedure 430, and only the contact list 340, to-do list 350, and Wi-Fi 380 modules are loaded on the device 600, as shown in FIG. 7.

Boot systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A boot system for use in a device, comprising:
a plurality of application modules, each of the application modules comprising a sub-boot procedure for booting an application;
a boot signal designating at least one of the application modules; and
a controller for generating a boot procedure according to the boot signal, wherein the boot procedure includes the sub-boot procedures of the designated application modules;
wherein the device boots based on the boot procedure in response to the boot signal.

2. The boot system of claim 1, wherein the boot procedure triggers software or hardware required for the applications corresponding to the designated application modules.

3. The boot system of claim 1 further comprising:
a basic function module, wherein the boot procedure includes a basic boot procedure for booting a basic function.

4. The boot system of claim 1 further comprising:
a means for downloading the application modules from a host.

5. The boot system of claim 1, wherein the application modules are Java programs.

6. The boot system of claim 1 further comprising:
an interface listing at least one of the application modules.

7. The boot system of claim 1, further comprising:
a table for recording the designated application modules and mapping the generated boot procedure to an input pattern.

8. The boot system of claim 7, wherein the input pattern is a button on a mobile phone.

9. The boot system of claim 1, wherein the boot system is an IC chip of a mobile phone.

10. A boot method for use in a device, comprising:
providing a plurality of application modules, each of the application modules comprising a sub-boot procedure for booting an application;
inputting a boot signal for designating at least one of the application modules; and
generating a boot procedure according to the boot signal, wherein the boot procedure includes the sub-boot procedures of the designated application modules;
wherein the device boots based on the boot procedure in response to the boot signal.

11. The boot method of claim 10, wherein the boot procedure triggers software or hardware required for the applications corresponding to the designated application modules.

12. The boot method of claim 10, further comprising:
providing a basic function module, wherein the boot procedure further includes a basic boot procedure for booting a basic function.

13. The boot method of claim 10 further comprising:
downloading the application modules from a host.

14. The boot method of claim 10, wherein the application modules are Java programs.

15. The boot method of claim 10 further comprising:
providing an interface listing at least one of the application modules.

16. The boot method of claim 10 further comprising:
storing a table for recording the designated application modules and mapping the generated boot procedure to an input pattern.

17. The boot method of claim 16, wherein the input pattern is a button on a mobile phone.

18. A mobile phone, comprising:
a basic function module comprising a basic boot procedure for booting a basic function;
a plurality of application modules, each of the application modules comprising a sub-boot procedure for booting an application;
a boot signal designating at least one of the application modules; and
a controller for generating a boot procedure according to the boot signal, wherein the boot procedure includes the basic boot procedure and the sub-boot procedures of the designated application modules,
wherein the device boots based on the boot procedure in response to the boot signal.

19. The mobile phone of claim 18, wherein the boot procedure triggers software or hardware required for the applications corresponding to the designated application modules.

20. The mobile phone of claim 18 further comprising:
a processing unit; and
a storage device;
wherein in response to the boot signal, the boot procedure triggers the processing unit and initiates the storage device.

21. The mobile phone of claim 18 further comprising:
a means for downloading the application modules from a host.

22. The mobile phone of claim 18, wherein the application modules are Java programs.

23. The mobile phone of claim 18 further comprising:
an interface listing at least one of the application modules.

24. The mobile phone of claim 20, wherein the storage device stores a table for recording the designated application modules and mapping the generated boot procedure to an input pattern.

25. The mobile phone of claim 24, wherein the input pattern is a button on the mobile phone.

26. A boot method for use in a mobile phone, comprising:
providing a basic function module comprising a basic boot procedure for booting a basic function;
downloading a plurality of application modules from a host, each of the application modules comprising a sub-boot procedure for booting an application;
selecting at least one of the downloaded application modules and inputting a boot signal; and
generating a boot procedure according to the boot signal, wherein the boot procedure includes the basic boot procedure and the sub-boot procedures of the selected application modules,
wherein the device boots based on the boot procedure in response to the boot signal.

27. The boot method of claim 26 further comprising: providing an interface listing all the downloaded application modules.

28. The boot method of claim 26, further comprising:
providing a table for recording the selected application modules and mapping the generated boot procedure to an input pattern.

29. The boot method of claim 28, wherein the input pattern is a button on the mobile phone.
